(19) United States
(12) Patent Application Publication
(10) Pub. No.: US 2016/0283514 A1
(43) Pub. Date: Sep. 29, 2016

(54) INFORMATION PROCESSING METHOD AND ELECTRONIC DEVICE

(71) Applicants: BEIJING LENOVO SOFTWARE LTD., BEIJING (CN); LENOVO (BEIJING) LIMITED, BEIJING (CN)

(72) Inventors: WEIDONG WEI, BEIJING (CN); YUEHUA ZHANG, BEIJING (CN)

(21) Appl. No.: 14/820,819

(22) Filed: Aug. 7, 2015

(30) Foreign Application Priority Data
Mar. 23, 2015 (CN) 201510128736.1
Mar. 24, 2015 (CN) 201510131847.8

(51) Int. Cl. G06F 17/30; G06F 21/31; H04L 29/08

(52) U.S. Cl. CPC G06F 17/30203; H04L 67/1097; G06F 17/30117; G06F 21/31; H04L 67/06

(57) ABSTRACT

The present disclosure provides an information processing method and an electronic device. The method comprises: detecting and obtaining first information, the first information being information communicated by a first user using a first electronic device with another user; determining whether there is a first file associated with the first information and satisfying a predetermined condition based on the first information; and storing, when it is determined that there is a first file associated with the first information and satisfying the predetermined condition, the first file in a network storage space associated with the first user, the network storage space being different from a first storage space where the first information is stored.

### CROSS REFERENCE

This application claims priority to the Chinese Patent Application No. 201510131847.8, filed on Mar. 24, 2015, entitled “INFORMATION PROCESSING METHOD AND ELECTROIC DEVICE” and the Chinese Patent Application No. 201510128736.1, filed on Mar. 23, 2015, entitled “INFORMATION PROCESSING METHOD AND ELECTRONIC DEVICE,” which are incorporated herein by reference in their entirety.

### TECHNICAL FIELD

The present disclosure relates to electronic technology, and more particularly, to an information processing method and an electronic device.

### BACKGROUND

With the development in multi-functionalization of electronic devices, various tools have been provided for interpersonal communications, including WeChat, Short Message Service (SMS), QQ, email and the like.

Given a certain capacity of an electronic device (e.g., a mobile phone, a tablet or a computer), when more and more data are stored in the electronic device, some unnecessary operations will no doubt occupy excessive storage space in the device. For example, when a user uses a mailbox having a certain capacity and the total number of emails has exceeded a particular ratio, any further increase in the number of e-mails will prevent the user from sending or receiving new emails. Hence, an email client will typically download emails received or transmitted earlier than an archiving date from a server and store them locally.

As the number of first files satisfying a predetermined condition (such as attachments to emails or video files) increases, the emails are typically archived manually or automatically onto a local server. Such emails cannot be read when the mailbox is accessed via Web. Further, in order to access the locally archived emails from another working machine, these archived files have to be copied onto a removable medium and read on the machine as attachments by using a corresponding client, which causes great inconvenience in the user's email management. Furthermore, if the user views the attachments to the emails on different working machines, these attachments have to be downloaded onto the local machines and subjected to a serial of processes (e.g., decompression) before they can be viewed. That is, it causes great inconvenience in the user's management of the first files satisfying the predetermined condition (e.g., attachments). Hence, the management of the first files satisfying the predetermined condition is complicated.

In practice, a user may often receive emails or instant messages containing links and can view files and webpages the links are linked to by clicking the links.

However, since the user may not be able to handle the received links in real time, some contents the links are linked to may have become invalid at the time when the user operates and thus cannot be retrieved by the user. Hence, the contents the links are linked to may have become invalid at the time when the user operates and thus cannot be retrieved by the user.

### SUMMARY

It is an object of the present disclosure to provide an information processing method and an electronic device, capable of solving the problem that management of first files satisfying a predetermined condition is complicated, thereby achieving a uniform management of the first files satisfying the predetermined condition.

In an aspect, an information processing method is provided according to an embodiment of the present disclosure. The method comprises: detecting and obtaining first information, the first information being information communicated by a first user using a first electronic device with another user; determining whether there is a first file associated with the first information and satisfying a predetermined condition based on the first information; and storing, when it is determined that there is a first file associated with the first information and satisfying the predetermined condition, the first file in a network storage space associated with the first user, the network storage space being different from a first storage space where the first information is stored.

Optionally, the predetermined condition comprises one or more of: the first file having not been stored in the network storage space; the first file having a first data size larger than a predetermined data size; the first file being required to be downloaded; and time to obtain the first information not exceeding a time limit to access the first file.

Optionally, the step of storing the first file in the network storage space associated with the first user comprises: obtaining authentication information for the network storage space associated with the first user; accessing the network storage space associated with the first user with the authentication information; and storing the first file in the network storage space associated with the first user.

Optionally, the method further comprises, subsequent to the step of storing, when it is determined that there is a first file associated with the first information and satisfying the predetermined condition, the first file in the network storage space associated with the first user: obtaining a first storage address in the network storage space where the first file is stored; generating second information based on the first storage address; and saving the second information in association with the first information.

Optionally, the method further comprises, subsequent to the step of saving the second information: detecting and obtaining a first operation by the first user with respect to the second information; and accessing, in response to the first operation, the first file in the network storage space based on the second information.

Optionally, the method further comprises, subsequent to the step of saving the second information: deleting the first file from the first information.

Optionally, the first file is an attachment to the first information.

Optionally, the first file is content a link in the first information is linked to, and the method further comprises, prior to the step of storing the first file in the network storage space associated with the first user: obtaining the content the link is linked to.

Optionally, the linked content is stored in a network storage space associated with a second user, the linked content in the network storage space associated with the second user being accessible by a user other than the second user by accessing the link, the second user being different from the first user.

Optionally, the method further comprises, subsequent to the step of storing, when it is determined that there is a first file associated with the first information and satisfying the predetermined condition, the first file in the network storage space associated with the first user: obtaining a first storage address in the network storage space where the first file is stored; and replacing the link with the first storage address.

In another aspect, an electronic device is provided according to an embodiment of the present disclosure. The electronic device comprises: a first detecting unit configured to detect and obtain first information, the first information being information communicated by a first user using a first electronic device with another user; a first determining unit configured to determine whether there is a first file associated with the first information and satisfying a predetermined condition based on the first information; and a first processing unit configured to store, when it is determined that there is a first file associated with the first information and satisfying the predetermined condition, the first file in a network storage space associated with the first user, the network storage space being different from a first storage space where the first information is stored.

Optionally, the predetermined condition comprises one or more of: the first file having not been stored in the network storage space; the first file having a first data size larger than a predetermined data size; the first file being required to be downloaded; and time to obtain the first information not exceeding a time limit to access the first file.

Optionally, the first processing unit is further configured to: obtain authentication information for the network storage space associated with the first user; access the network storage space associated with the first user with the authentication information; and store the first file in the network storage space associated with the first user.

Optionally, the electronic device further comprises: a first obtaining unit configured to obtain a first storage address in the network storage space where the first file is stored; a first generating unit configured to generate second information based on the first storage address; and a first saving unit configured to save the second information in association with the first information.

Optionally, the electronic device further comprises: a second detecting unit configured to detect and obtain a first operation by the first user with respect to the second information; and a second processing unit configured to access, in response to the first operation, the first file in the network storage space based on the second information.

Optionally, the electronic device further comprises: a first deleting unit configured to delete the first file from the first information.

Optionally, the first file is content a link in the first information is linked to, and the electronic device further comprises: a content obtaining unit configured to obtain the content the link is linked to.

Optionally, the linked content is stored in a network storage space associated with a second user, the linked content in the network storage space associated with the second user being accessible by a user other than the second user by accessing the link, the second user being different from the first user.

Optionally, the electronic device further comprises: a first obtaining unit configured to obtain a first storage address in the network storage space where the first file is stored; and a link replacing unit configured to replace the link with the first storage address.

One or more solutions according the above embodiments of the present disclosure have at least the following one or more technical effects.

In a solution according to the present disclosure, when a first file, e.g., an attachment to an email, satisfying a predetermined condition is obtained from first information communicated by a first user using a first electronic device with another user, the first electronic device automatically stores the first file in a network storage space associated with the first user. In this way, the first user can uniformly manage the first file stored in the network storage space by simply logging into his/her network storage space account, thereby achieving a uniform management of the first file satisfying the predetermined condition.

In a solution according to the present disclosure, a first file satisfying a predetermined condition is automatically stored in a network storage space associated with a user. In this way, the file can be automatically backed up.

In a solution according to the present disclosure, a first file satisfying a predetermined condition is stored in a network storage space associated with a user, a first storage address in the network storage space where the first file is stored can be obtained and second information is generated based on the first storage address. Further, the second information is saved and the first file is deleted from the first information, thereby relieving occupation of the storage space in the first electronic device by the first file. In this way, the occupation of the storage space can be reduced.

In a solution according to the present disclosure, a first file satisfying a predetermined condition is stored in a network storage space associated with a user, a first storage address in the network storage space where the first file is stored can be obtained and second information is generated based on the first storage address. When a first operation by the first user with respect to the second information is detected, the first file in the network storage space is accessed based on the second information in response to the first operation. For example, an external link to the uploaded first file can be added to an email, such that an attachment to the email can be viewed on any networked computer. Hence, the user can view the file anytime as desired.

In a solution according to the present disclosure, if the first information contains a link, and the first file satisfying the predetermined condition is stored in the network storage space associated with the user, the content the link is linked to, if satisfies a predetermined condition, can be stored in the network storage space, such that the linked content can be valid in a long term. Hence, the solution according to the embodiment of the present disclosure effectively solves the problem that the contents the links are linked to may have become invalid at the time when the user operates and thus cannot be retrieved by the user. In this way, it is possible to ensure the validity of the linked content.

In a solution according to the present disclosure, after the first information has been obtained, it is determined whether the first file associated with the first information satisfies the predetermined condition. If so, the first file can be stored in the network storage space associated with the user; otherwise no process can be applied to the first file. That is, it is determined whether to store the first file in the network storage space based on its property, thereby achieving a classified processing of the first file.

In a solution according to the present disclosure, if the first information contains a link, after the content the link is linked to has been stored in the network storage space, the original link, which has become invalid, can be replaced with the address information of the network storage space. In this way, when the user clicks the link to view the linked content, the content in the network storage space can be automatically linked to, thereby ensuring the validity of the linked content.

### BRIEF DESCRIPTION OF THE DRAWINGS

In order to illustrate some embodiments of the present disclosure clearly, the figures used for description of the embodiments will be introduced briefly here. It is apparent to those skilled in the art that the figures described below only illustrate some embodiments of the present disclosure.

FIG. 1 is a flowchart illustrating an information processing method according to a first embodiment of the present disclosure;

FIG. 2 is a flowchart illustrating an exemplary implementation of the step S103 in the information processing method according to the first embodiment of the present disclosure;

FIG. 3 is a flowchart illustrating an exemplary implementation of the process subsequent to the step S103 in the information processing method according to the first embodiment of the present disclosure;

FIG. 4 is a flowchart illustrating an exemplary implementation of the process subsequent to the step S203 in the information processing method according to the first embodiment of the present disclosure; and

FIG. 5 is a block diagram showing a structure of an electronic device according to a second embodiment of the present disclosure.

### DETAILED DESCRIPTION OF THE EMBODIMENTS

The embodiments of the present disclosure provides an information processing method and an electronic device, capable of solving the problem that management of first files satisfying a predetermined condition is complicated, thereby achieving a uniform management of the first files satisfying the predetermined condition.

An information processing method is provided. The method comprises: detecting and obtaining first information, the first information being information communicated by a first user using a first electronic device with another user; determining whether there is a first file associated with the first information and satisfying a predetermined condition based on the first information; and storing, when it is determined that there is a first file associated with the first information and satisfying the predetermined condition, the first file in a network storage space associated with the first user, the network storage space being different from a first storage space where the first information is stored.

In a solution according to the present disclosure, when a first file, e.g., an attachment to an email, satisfying a predetermined condition is obtained from first information communicated by a first user using a first electronic device with another user, the first electronic device automatically stores the first file in a network storage space associated with the first user. In this way, the first user can uniformly manage the first file stored in the network storage space by simply logging into his/her network storage space account, thereby achieving a uniform management of the first file satisfying the predetermined condition.

In the following, the solutions of the present disclosure will be described in detail with reference to the figures and the embodiments. It should be noted that the embodiments of the present disclosure and their specific features are given for illustrating the solutions of the present disclosure and are not intended to limit the scope of the present disclosure. The embodiments of the present disclosure and their specific features can be combined with each other, provided that they do not conflict.

In the embodiments of the present disclosure, examples of the first electronic device include, among others, a desktop computer, a notebook computer, a smart phone, or an electronic device such as a tablet computer. In the following embodiments, the solutions according to the present disclosure will be described in detail, assuming that the first electronic device is a notebook computer as an example.

### First Embodiment

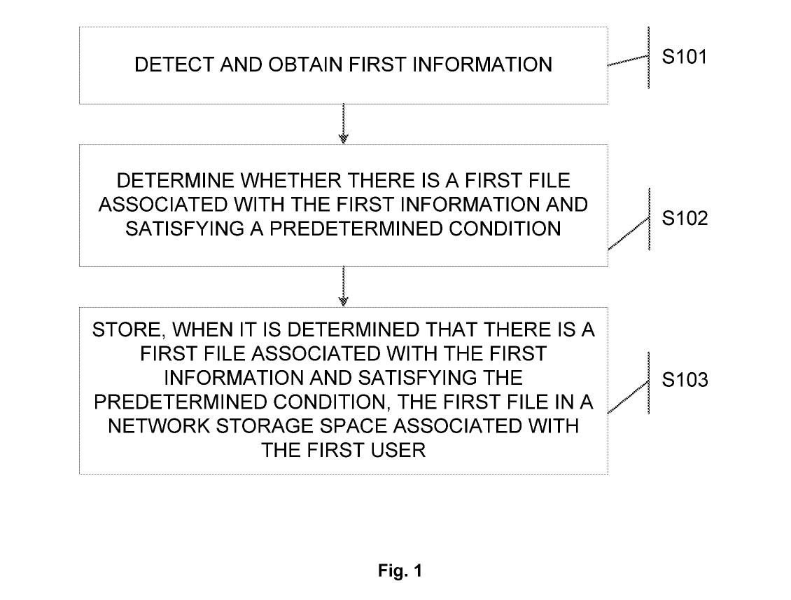

Referring to FIG. 1, an information processing method and an electronic device are provided according to a first embodiment of the present disclosure. The method includes the following steps.

At step S101, first information is detected and obtained. The first information is information communicated by a first user using a first electronic device with another user.

At step S102, it is determined whether there is a first file associated with the first information and satisfying a predetermined condition based on the first information.

At step S103, when it is determined that there is a first file associated with the first information and satisfying the predetermined condition, the first file is stored in a network storage space associated with the first user. The network storage space is different from a first storage space where the first information is stored.

In the embodiment of the present disclosure, the steps S101˜S103 can be implemented as follows.

In an implementation, an OUTLOOK application for sending/receiving emails, a QQ application or a WeChat application can be installed in a notebook computer. Plug-ins corresponding to the OUTLOOK, QQ or Wechat application can also be installed in the notebook computer for capturing a sending or receiving instruction triggered by a user of the notebook computer in an interface for sending an email or a chatting window of QQ or WeChat. In the embodiment of the present disclosure, the first information may be an email or an instant message such as a QQ or WeChat message, or any other messages communicated between users.

For example, User A receives an email sent from User B via an email client in the notebook computer. In this case, the received email is the first information. As another example, User A sends an email to User B via an email client in the notebook computer and the sent email is stored in the email client. In this case, the sent email is the first information.

After obtaining the first information, the method proceeds with the step S102 where it is determined whether there is a first file associated with the first information and satisfying a predetermined condition based on the first information.

In the embodiment of the present disclosure, the predetermined condition may include one or more of: the first file having not been stored in the network storage space; the first file having a first data size larger than a predetermined data size; the first file being required to be downloaded; and time to obtain the first information not exceeding a time limit to access the first file.

Accordingly, the determination in the step S102 may include, but not limited to, the following six determination schemes.

### First Determination Scheme

In this scheme, it is determined whether the first file has been stored in the network storage space. That is, in order to avoid uploading the first file repeatedly, before uploading the first file into the network storage space, it is determined whether the first file to be uploaded has existed in the network storage space. If so, there would be no need to upload it again, thereby omitting the process for uploading the first file here and saving network resources. Otherwise, the first file is uploaded. For example, an OUTLOOK email client typically has mailboxes, including such as inbox, outbox, draft and deleted. For each email in the mailboxes, it is determined first whether the first file in the email has been stored in the network storage space of the user. If so, it will not be stored again; otherwise it will be stored. Without the determination as to whether the first file has been stored, the first file may be backed up repeatedly, resulting in increased complexity in the process.

### Second Determination Scheme

In this scheme, it is determined whether the first file has a first data size larger than a predetermined data size. That is, the first file satisfying the predetermined condition can be obtained based on the data size of the file. Instead of processing all the first files, only files having sizes exceeding the predetermined data size will be processed. For example, a received email in an OUTLOOK email client includes a first attachment having a size of 2M and a second attachment having a size of 300K. If the predetermined data size is 1M, the size of the first attachment is larger than the predetermined data size and the size of the second attachment is smaller than the predetermined data size. By comparing the size of each attachment with the predetermined data size, it can be determined whether the email has any file satisfying the predetermined condition. In the embodiment of the present disclosure, the predetermined data size can be preset based on the configuration of storage capacity of emails by the server, and can be flexibly adjusted based on the current network environment, so as to adapt the predetermined data size to the current network environment. The predetermined data size can be e.g., 5M, 10M, 15M, or any other data size. The predetermined data size can be set as desired and the embodiment of the present disclosure is not limited thereto.

### Third Determination Scheme

In this scheme, it is determined whether the first file is required to be downloaded. When the first user receives an email containing a link, there may be various types of contents the link is linked to, e.g., advertisement information, website activation information or a download link to a file. Instead of processing all types of linked contents, only linked contents the user is interested in or useful to the user can be stored. In the embodiment of the present disclosure, in an example where the linked content to be processed is a content to be downloaded, the first user receives an email containing a link linking to a download content, e.g., the content the link is linked to is to download a song. The song can be downloaded by clicking the link and is the first file satisfying the predetermined condition. It can be appreciated by those skilled in the art that the property of the first file satisfying the predetermined condition can be set as desired. For example, the first file satisfying the predetermined condition can be set as linked content that is website activation information and the present disclosure is not limited thereto.

### Fourth Determination Scheme

In this scheme, it is determined whether time to obtain the first information exceeds a time limit to access the first file. When the first user receives an email containing a link, such link may link to linked content having a time limit. For example, the main body of the email may include information such as “valid within 7 days”, which indicates that the linked content can be operated within 7 days from receipt of the email and will be invalid when the time limit of 7 days expires. Thus, a link having a time limit needs to be processed by the user in time; otherwise the link will become invalid. In the embodiment of the present disclosure, linked content that has a time limit and the time has not exceeded the time limit is used as the first file satisfying the predetermined condition for further processing.

### Fifth Determination Scheme

This scheme is based on the first and second determination schemes. In particular, it is determined whether the first file has been stored in the network storage space. If not, it is then determined whether the first file has a first data size larger than a predetermined data size. That is, it is first determined whether the first file has been stored in the network storage space. When it is determined that the first file has not been stored, it is then determined whether the data size of the first file is larger than a predetermined data size. In this way, repeated backups for the stored file can be avoided while ensuring that a file exceeding the predetermined data size will be backed up.

### Sixth Determination Scheme

This scheme is based on the third and fourth determination schemes. In particular, it is determined whether the first file is required to be downloaded. If so, it is then determined whether the time at which the first information is received exceeds a time limit to access the first file. For example, the first user receives an email containing a link and content the link is linked to is a picture stored in the second user's online storage where it can be stored for only 10 days. That is, if it is not downloaded within 10 days, it would be deleted and the user would not be able to download or view it. In the embodiment of the present discourse, the picture corresponding to the link in the email is used as the first file satisfying the predetermined condition.

Further, in the embodiment of the present disclosure, it may be determined whether the detected file property is a predetermined file property, which could be e.g., attachment, audio file or image file. When the detected file property is attachment, it can be compared with the predetermined file property. Of course there are other determination schemes which can be set by those skilled in the art as desired.

In the embodiment of the present disclosure, no matter which of the determination schemes is used, the purpose is to determine whether there is a first file associated with the first information and satisfying the predetermined condition. The implementation of the step S102 varies as the content of the first information varies. For example, when the first information is a first email, the first email includes mainly a main body portion and an attachment portion. In particular, there may be a subject matter portion and a main body portion. For example, various multimedia files, such as images and videos, can be embedded into the main body, such that the recipient can browse the image and video files in the email directly by opening the email. Alternatively, there may be a subject matter portion and an attachment portion. For example, there may be one or more folders in the attachment. There may be various types of files in the attachment, including audio, video, image, text and executable files. Alternatively, there may be a main body portion and an attachment portion. In this case, image and video files can be embedded into the main body, or audio and video files can be added to the email as attachments. Further examples will be omitted here.

It can be seen from the above description regarding the composition of the first email that the email contents in form of attachments may cause the storage capacity of the contents in the email to exceed a predetermined capacity threshold. In addition, the multimedia files embedded into the main body of the email may also cause the storage capacity of the contents in the email to exceed the predetermined capacity threshold. No matter in which form the contents are contained in the email, whenever their storage capacity exceeds the predetermined capacity threshold, certain processes need to be applied to the contents exceeding the predetermined capacity threshold.

Thus, in the embodiment of the present disclosure, when the first information is a first email, the first file associated with the first information can be an attachment to the first email, a video file, an audio file, an image file or a text file contained in the main body of the first email, content a link contained in the main body of the first email is linked to, or any other type of file. The embodiment of the present disclosure is not limited to this.

In the embodiment of the present disclosure, when the first information is instant information, it can be QQ information, WeChat information, IP Messenger information or any other instant information and the embodiment of the present disclosure is not limited thereto. In a case where a QQ or IP Messenger user sends information to one friend or a group of friends, when a first sending instruction generated when the user triggers a sending operation for sending QQ or IP Messenger information is detected, the first information sent by the user can be obtained and the first file associated with the first information can be determined. Here the first file may be in particular an audio file, a video file, an image file or any other type of file and the embodiment of the present disclosure is not limited thereto. Of course, the first information can be received or sent information communicated between the user and other users. Then, the determination can be made on the first file associated with the information and details of the determination schemes will be omitted here.

Subsequent to the step S102, the method proceeds with the step S103 where, when it is determined that there is a first file associated with the first information and satisfying the predetermined condition, the first file is stored in a network storage space associated with the first user. The network storage space is different from a first storage space where the first information is stored. For example, when the first file is a first attachment satisfying the predetermined condition, the first attachment can be automatically uploaded to the network storage space corresponding to the user's account. Here the network storage space can be e.g., the user's online storage or a cloud server and the present disclosure is not limited to any specific type of the network storage space. After the first file has been stored in the network storage space corresponding to the user's account, the user can log into his/her network storage space account to view, modify or otherwise manage the first file stored therein. Further, the user associated with the network storage space corresponds to the first user, e.g., in a one-to-one correspondence. That is, the user associated with the network storage space account is the user who stores the first file. Alternatively, the user associated with the network storage space can be bound to the first user and details thereof will be omitted here.

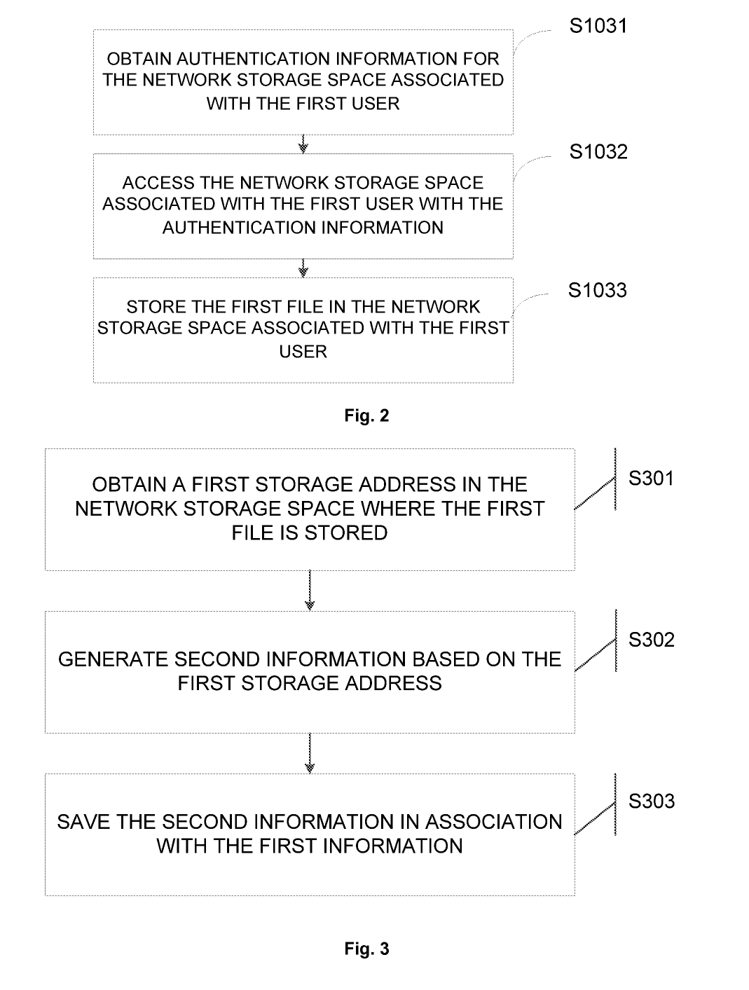

Further, as shown in FIG. 2, the step S103 may include the following sub-steps.

At step S1031, authentication information for the network storage space associated with the first user is obtained.

At step S1032, the network storage space associated with the first user is accessed with the authentication information.

At step S1033, the first file is stored in the network storage space associated with the first user.

In particular, when the first file (e.g., content a link contained in an email is linked to) associated with the first information received by the first user and satisfying the predetermined condition is stored in the network storage space of the first user (e.g., an online storage of the first user), the user needs to log into the online storage first. In this case, an account and a password to log into the first user's online storage need to be obtained, which are authentication information for the network storage space. When it is required to save the first file in the online storage, the user can log into the online storage with the account and the password automatically and save the first file in the online storage. Of course, in a case where the first user uses a computer to view emails, when he/she activates an application for receiving emails (e.g., outlook), the login operation to the online storage can be automatically performed as outlook is activated. The login information can be determined based on the information of the first user, i.e., the information of the recipient, so as to ensure that the first file associated with the first information and satisfying the predetermined condition as received by the first user can be stored in the first user's online storage, rather than in a second user's online storage.

Further, in order to guarantee the confidentiality of the first file, the first file can be encrypted and stored in the online storage. For example, the first user can preset an encryption code and, when there is a first file associated with the first information of the first user and satisfying the predetermined condition, it can be encrypted with the preset encryption code and then stored in the online storage. When the first user logs into the online storage, he/she needs to decrypt the first file before viewing it.

In the embodiment of the present disclosure, referring to FIG. 3, the method may further include the following steps subsequent to the step S103.

At step S301, a first storage address in the network storage space where the first file is stored is obtained.

At step S302, second information is generated based on the first storage address.

At step S303, the second information is saved in association with the first information.

In particular, the steps S301˜S303 are implemented as follows.

After the first file has been stored in the network storage space associated with the first user, the first storage address in the network storage space where the first file is stored can be obtained based on the specified directory in the network storage space where the first file is stored. Then, the second information is generated based on the first storage address. In the embodiment of the present disclosure, the second information can only contain “external link” information corresponding to the first storage address, which is stored in association with the first information. In addition, the “external link” information is visible to the user viewing the email. In addition to the “external link” information corresponding to the first storage address, the second information may contain the name, size and summary of the first information, such that the recipient of the email can learn the contents in the attachment from the second information quickly and conveniently and decide whether to obtain the content of the first file by using the second information. In this way, the user can determine whether to obtain the first file by using the second information based on the additional content presented by the second information. The first file will not be downloaded when it is not required, such that the network resources can be saved. Additionally, in the embodiment of the present disclosure, the second information can be saved at any position in the first information. For example, an attachment of an email that satisfies a predetermined condition can be uploaded onto a specified directory in the user's online storage space and link information (i.e., the second information) indicative of the location where the attachment is stored can be saved at any position in the main body of the email, at the subject matter of the email, at the position of the attachment, or at any other position (details thereof will be omitted here).

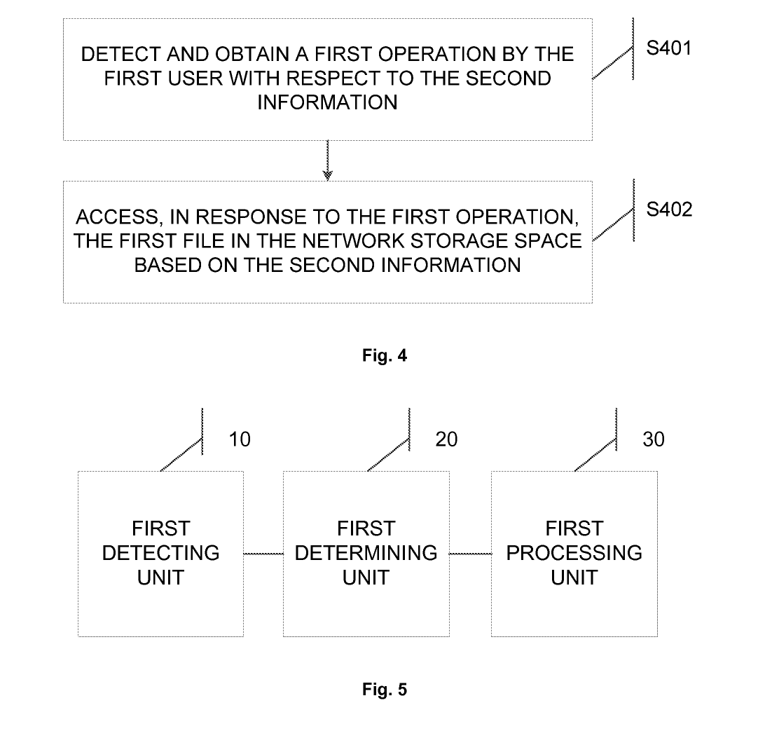

In the embodiment of the present disclosure, referring to FIG. 4, the method may include the following steps after the second information has been obtained.

At step S401, a first operation by the first user with respect to the second information is detected and obtained.

At step S402, in response to the first operation, the first file in the network storage space is accessed based on the second information.

In particular, the steps S401˜S402 are implemented as follows.

Since the second information is generated based on the first storage address, when the first operation by the first user with respect to the second information is detected, in response to the first operation, the user can access the first file in the network storage space based on the second information. For example, with the solution according to the embodiment of the present disclosure, first link information corresponding to the first attachment contained in the first email in the inbox of the user's mailbox can be provided at the position where the first attachment was located. When the user is viewing the first email, he/she can click the first link information. After the click operation by the user is detected, the user's online storage space can be logged into based on the first link information, thereby the user can access the first attachment uploaded onto the online storage space.

In the embodiment of the present disclosure, after the second information has been saved, the first file can be deleted from the first information. For example, an attachment or a video file satisfying the predetermined condition can be deleted from the email, with only the link information corresponding to the file satisfying the predetermined condition retained in the email. In this way, on one hand, in an email server where the emails are stored, the storage space for storing emails with attachments can be significantly reduced since the attachments are no longer stored. Thus, it is possible to store more emails and avoid the need for the user to frequently process the emails in the email server. On the other hand, for emails that have been locally archived, there is no need to store their attachments, such that the occupation of the local storage space can be significantly reduced.

In the embodiment of the present disclosure, if the first file is content a link in the first information is linked to, the content the link is linked to needs to be obtained before the first file can be stored in the network storage space associated with the first user.

In an implementation, the linked content is stored in a network storage space associated with a second user. The linked content in the network storage space associated with the second user is accessible by a user other than the second user by accessing the link. The second user may be different from the first user.

In particular, the second user is a user different from the first user and has an associated network storage space, such as an online storage. The online storage can store many files each having unique online storage address information. For example, a movie is stored in the online storage of the second user and has its online storage address information of http://pan.abc.com/dianying. Other users can access the movie stored in the online storage of the second user by clicking the link. When the first user receives an email containing the link http://pan.abc.com/dianying, he/she can access the movie stored in the online storage of the second user by clicking the link.

In the embodiment of the present disclosure, if the first file is content a link in the first information is linked to, the method further includes, subsequent to the step S103: obtaining a first storage address in the network storage space where the first file is stored; and replacing the link with the first storage address.

In particular, when the first user receives an email containing a link http://pan.user.com/picture and the content the link is linked to is a picture having a time limit, the picture the link is linked to is obtained and saved in the first user's online storage. The address in the first user's online storage where the picture is stored is http://pan.user1.com/pic. In order to prevent the first user from clicking the original link http://pan.user.com/picture which has become invalid after the time limit has expired, the original link http://pan.user.com/picture can be replaced with the address in the first user's online storage where the picture is stored, i.e., http://pan.user1.com/pic. In this way, when the user clicks http://pan.user1.com/pic, it can be ensured that the current link contained in the email is valid permanently.

In addition, in the embodiment of the present disclosure, the user's online storage account can be automatically logged into for automatic detection. For example, information in the inbox, outbox, draft, sent SMS messages and received SMS messages can be automatically detected. If there is a file satisfying the predetermined condition that has not been uploaded to the online storage, it will be automatically uploaded in background. For example, when a new email or SMS message is received, it is possible to automatically detect whether it contains a first file satisfying the predetermined condition. If so, the first file will be uploaded onto the online storage automatically in background.

In addition, in the embodiment of the present disclosure, the first information can be a first email containing a first attachment. When the first email is to be received by only one email recipient, a first data amount for the first file is the data amount of the first attachment. When there are a number (e.g., 5) of email recipients and the data amount of the first attachment is 5M, the first data amount is a multiple of the data amount of the first attachment, i.e., 25M. The attachment satisfying the predetermined condition is uploaded to the user's online storage. Accordingly, link information is generated at a local server. That is, with the solution according to the embodiment of the present disclosure, an email having only link information for an attachment is sent. The user can view or download the attachment based on the link information only when he/she wants to. In this way, there is no need to send emails having attachments. When an email having an attachment is copied to a large number of recipients, sending this email to all the recipients will cause a high load on the network.

In addition, in the embodiment of the present disclosure, the first information can be instant information containing a second file. When there is only one recipient, the first data amount is the data amount of the second file. When there are a number (e.g., 5) of recipients and the data amount of the second file is 10M, the first data amount is a multiple of the data amount of the second file, i.e., 50M. In this case, the file satisfying the predetermined condition is uploaded onto the user's online storage account. Accordingly, link information is generated at a local server. In this way, the load on the network caused by sending instant information to multiple recipients can be relieved. Accordingly, the network bandwidth can be saved and the network can be efficiently utilized.

### Second Embodiment

Based on the same inventive concept, an electronic device is provided according to the embodiment of the present disclosure. Referring to FIG. 5, the electronic device includes the following units.

A first detecting unit 10 is configured to detect and obtain first information, the first information being information communicated by a first user using a first electronic device with another user.

A first determining unit 20 is configured to determine whether there is a first file associated with the first information and satisfying a predetermined condition based on the first information.

A first processing unit 30 is configured to store, when it is determined that there is a first file associated with the first information and satisfying the predetermined condition, the first file in a network storage space associated with the first user, the network storage space being different from a first storage space where the first information is stored.

In the embodiment of the present disclosure, the predetermined condition includes one or more of: the first file having not been stored in the network storage space; the first file having a first data size larger than a predetermined data size; the first file being required to be downloaded; and time to obtain the first information not exceeding a time limit to access the first file.

In the embodiment of the present disclosure, the first processing unit is further configured to: obtain authentication information for the network storage space associated with the first user; access the network storage space associated with the first user with the authentication information; and store the first file in the network storage space associated with the first user.

In the embodiment of the present disclosure, the electronic device further includes: a first obtaining unit configured to obtain a first storage address in the network storage space where the first file is stored; a first generating unit configured to generate second information based on the first storage address; and a first saving unit configured to save the second information in association with the first information.

In the embodiment of the present disclosure, in order to allow the user to view the first file on any networked electronic device, the electronic device further includes: a second detecting unit configured to detect and obtain a first operation by the first user with respect to the second information; and a second processing unit configured to access, in response to the first operation, the first file in the network storage space based on the second information.

In the embodiment of the present disclosure, in order to reduce the occupation of the storage space of the electronic device by the first file, the electronic device further includes: a first deleting unit configured to delete the first file from the first information.

In the embodiment of the present disclosure, the first file is content a link in the first information is linked to, and the electronic device further includes: a content obtaining unit configured to obtain the content the link is linked to.

In the embodiment of the present disclosure, the linked content is stored in a network storage space associated with a second user, the linked content in the network storage space associated with the second user being accessible by a user other than the second user by accessing the link, the second user being different from the first user.

In the embodiment of the present disclosure, the first file is content a link in the first information is linked to and, in order to make the link permanently valid, the electronic device further includes: a first obtaining unit configured to obtain a first storage address in the network storage space where the first file is stored; and a link replacing unit configured to replace the link with the first storage address.

One or more solutions according the above embodiments of the present disclosure have at least the following one or more technical effects.

In a solution according to the present disclosure, when a first file, e.g., an attachment to an email, satisfying a predetermined condition is obtained from first information communicated by a first user using a first electronic device with another user, the first electronic device automatically stores the first file in a network storage space associated with the first user. In this way, the first user can uniformly manage the first file stored in the network storage space by simply logging into his/her network storage space account, thereby achieving a uniform management of the first file satisfying the predetermined condition.

In a solution according to the present disclosure, a first file satisfying a predetermined condition is automatically stored in a network storage space associated with a user. In this way, the file can be automatically backed up.

In a solution according to the present disclosure, a first file satisfying a predetermined condition is stored in a network storage space associated with a user, a first storage address in the network storage space where the first file is stored can be obtained and second information is generated based on the first storage address. Further, the second information is saved and the first file is deleted from the first information, thereby relieving occupation of the storage space in the first electronic device by the first file. In this way, the occupation of the storage space can be reduced.

In a solution according to the present disclosure, a first file satisfying a predetermined condition is stored in a network storage space associated with a user, a first storage address in the network storage space where the first file is stored can be obtained and second information is generated based on the first storage address. When a first operation by the first user with respect to the second information is detected, the first file in the network storage space is accessed based on the second information in response to the first operation. For example, an external link to the uploaded first file can be added to an email, such that an attachment to the email can be viewed on any networked computer. Hence, the user can view the file anytime as desired.

In a solution according to the present disclosure, if the first information contains a link, and the first file satisfying the predetermined condition is stored in the network storage space associated with the user, the content the link is linked to, if satisfies a predetermined condition, can be stored in the network storage space, such that the linked content can be valid in a long term. Hence, the solution according to the embodiment of the present disclosure effectively solves the problem that the contents the links are linked to may have become invalid at the time when the user operates and thus cannot be retrieved by the user. In this way, it is possible to ensure the validity of the linked content.

In a solution according to the present disclosure, after the first information has been obtained, it is determined whether the first file associated with the first information satisfies the predetermined condition. If so, the first file can be stored in the network storage space associated with the user; otherwise no process can be applied to the first file. That is, it is determined whether to store the first file in the network storage space based on its property, thereby achieving a classified processing of the first file.

In a solution according to the present disclosure, if the first information contains a link, after the content the link is linked to has been stored in the network storage space, the original link, which has become invalid, can be replaced with the address information of the network storage space. In this way, when the user clicks the link to view the linked content, the content in the network storage space can be automatically linked to, thereby ensuring the validity of the linked content.

It can be appreciated by those skilled in the art that the embodiments of the present disclosure can be implemented as a method, a system or a computer program product. The present disclosure may include pure hardware embodiments, pure software embodiments and any combination thereof. Also, the present disclosure may include a computer program product implemented on one or more computer readable storage medium (including, but not limited to, magnetic disk storage, CD-ROM, optical storage) containing computer readable program codes.

The present disclosure have been described with reference to the flowcharts and/or block diagrams of the method, device (system) and computer program product according to the embodiments of the present disclosure. It can be appreciated that each process and/or block in the flowcharts and/or block diagrams, or any combination thereof, can be implemented by computer program instructions. Such computer program instructions can be provided to a general computer, a dedicated computer, an embedded processor or a processor of any other programmable data processing device to constitute a machine, such that the instructions executed by the computer or the processor of any other programmable data processing device can constitute means for implementing the functions specified by one or more processes in the flowcharts and/or one or more blocks in the block diagrams.

These computer program instructions can also be stored in a computer readable memory that can direct a computer or any other programmable data processing device to operate in a particular way. Thus, the instructions stored in the computer readable memory constitute an article of manufacture including instruction means for implementing the functions specified by one or more processes in the flowcharts and/or one or more blocks in the block diagrams.

These computer program instructions can also be loaded onto a computer or any other programmable data processing device, such that the computer or the programmable data processing device can perform a series of operations/steps to achieve a computer-implemented process. In this way, the instructions executed on the computer or the programmable data processing device can provide steps for implementing the functions specified by one or more processes in the flowcharts and/or one or more blocks in the block diagrams.

In particular, the computer program instructions for implementing the information processing method according to the embodiment of the present disclosure can be stored on a storage medium such as an optical disc, a hard disk or a flash memory. The computer program instructions stored in the storage medium for implementing the information processing method include, when read or executed by an electronic device, the following steps of: detecting and obtaining first information, the first information being information communicated by a first user using a first electronic device with another user; determining whether there is a first file associated with the first information and satisfying a predetermined condition based on the first information; and storing, when it is determined that there is a first file associated with the first information and satisfying the predetermined condition, the first file in a network storage space associated with the first user, the network storage space being different from a first storage space where the first information is stored.

Optionally, the computer program instructions stored in the storage medium for determining whether there is a first file associated with the first information and satisfying a predetermined condition based on the first information include computer program instructions, when executed, for: determining whether a file associated with the first information satisfies the predetermined condition, the predetermined condition including one or more of: the first file having not been stored in the network storage space; the first file having a first data size larger than a predetermined data size; the first file being required to be downloaded; and time to obtain the first information not exceeding a time limit to access the first file.

Optionally, the computer program instructions stored in the storage medium for storing the first file in the network storage space associated with the first user include computer program instructions, when executed, for: obtaining authentication information for the network storage space associated with the first user; accessing the network storage space associated with the first user with the authentication information; and storing the first file in the network storage space associated with the first user.

Optionally, the computer program instructions stored in the storage medium include computer program instructions, when executed subsequent to storing, when it is determined that there is a first file associated with the first information and satisfying the predetermined condition, the first file in the network storage space associated with the first user, for: obtaining a first storage address in the network storage space where the first file is stored; generating second information based on the first storage address; and saving the second information in association with the first information.

Optionally, the computer program instructions stored in the storage medium include computer program instructions, when executed subsequent to saving the second information, for: detecting and obtaining a first operation by the first user with respect to the second information; and accessing, in response to the first operation, the first file in the network storage space based on the second information.

Optionally, the computer program instructions stored in the storage medium include computer program instructions, when executed subsequent to saving the second information, for: deleting the first file from the first information.

Optionally, the first file is content a link in the first information is linked to. The computer program instructions stored in the storage medium include computer program instructions, when executed prior to storing the first file in the network storage space associated with the first user, for: obtaining the content the link is linked to.

In particular, the linked content is stored in a network storage space associated with a second user, the linked content in the network storage space associated with the second user being accessible by a user other than the second user by accessing the link, the second user being different from the first user.

Optionally, the first file is content a link in the first information is linked to. The computer program instructions stored in the storage medium include computer program instructions, when executed subsequent to storing, when it is determined that there is a first file associated with the first information and satisfying the predetermined condition, the first file in the network storage space associated with the first user, for: obtaining a first storage address in the network storage space where the first file is stored; and replacing the link with the first storage address.

While the preferred embodiments of the present disclosure have been described above, various modifications and alternatives to these embodiments can be made by those skilled in the art based on the fundamental inventive concept. Therefore, these preferred embodiments and all the modifications and alternatives falling within the scope of the present disclosure are to be encompassed by the claims as attached.

Obviously, various modifications and alternatives can be made to the present disclosure by those skilled in the art without departing from the spirit and scope of the present disclosure. Therefore, these modifications and alternatives are to be encompassed by the present disclosure if they fall within the scope of the claims and their equivalents.

What is claimed is:

1. An information processing method, comprising:
detecting and obtaining first information, the first information being information communicated by a first user using a first electronic device with another user;
determining whether there is a first file associated with the first information and satisfying a predetermined condition based on the first information; and
storing, when it is determined that there is a first file associated with the first information and satisfying the predetermined condition, the first file in a network storage space associated with the first user, the network storage space being different from a first storage space where the first information is stored.

2. The method of claim 1, wherein the predetermined condition comprises one or more of:
the first file having not been stored in the network storage space;
the first file having a first data size larger than a predetermined data size;
the first file being required to be downloaded; and
time to obtain the first information not exceeding a time limit to access the first file.

3. The method of claim 2, wherein said storing the first file in the network storage space associated with the first user comprises:
obtaining authentication information for the network storage space associated with the first user;
accessing the network storage space associated with the first user with the authentication information; and
storing the first file in the network storage space associated with the first user.

4. The method of claim 1, further comprising, subsequent to said storing, when it is determined that there is a first file associated with the first information and satisfying the predetermined condition, the first file in the network storage space associated with the first user:
obtaining a first storage address in the network storage space where the first file is stored;
generating second information based on the first storage address; and
saving the second information in association with the first information.

5. The method of claim 4, further comprising, subsequent to said saving the second information:
detecting and obtaining a first operation by the first user with respect to the second information; and
accessing, in response to the first operation, the first file in the network storage space based on the second information.

6. The method of claim 4, further comprising, subsequent to said saving the second information:
deleting the first file from the first information.

7. The method of claim 6, wherein the first file is an attachment to the first information.

8. The method of claim 1, wherein the first file is content a link in the first information is linked to, and the method further comprises, prior to said storing the first file in the network storage space associated with the first user:
obtaining the content the link is linked to.

9. The method of claim 8, wherein the linked content is stored in a network storage space associated with a second user, the linked content in the network storage space associated with the second user being accessible by a user other than the second user by accessing the link, the second user being different from the first user.

10. The method of claim 9, further comprising, subsequent to said storing, when it is determined that there is a first file associated with the first information and satisfying the predetermined condition, the first file in the network storage space associated with the first user:
obtaining a first storage address in the network storage space where the first file is stored; and
replacing the link with the first storage address.

11. An electronic device, comprising:
a first detecting unit configured to detect and obtain first information, the first information being information communicated by a first user using a first electronic device with another user;
a first determining unit configured to determine whether there is a first file associated with the first information and satisfying a predetermined condition based on the first information; and
a first processing unit configured to store, when it is determined by the first determining unit that there is a first file associated with the first information and satisfying the predetermined condition, the first file in a network storage space associated with the first user, the network storage space being different from a first storage space where the first information is stored.

12. The electronic device of claim 11, wherein the predetermined condition comprises one or more of:
the first file having not been stored in the network storage space;
the first file having a first data size larger than a predetermined data size;
the first file being required to be downloaded; and
time to obtain the first information not exceeding a time limit to access the first file.

13. The electronic device of claim 11, wherein the first processing unit is further configured to:
obtain authentication information for the network storage space associated with the first user;
access the network storage space associated with the first user with the authentication information; and
store the first file in the network storage space associated with the first user.

14. The electronic device of claim 11, further comprising:
a first obtaining unit configured to obtain a first storage address in the network storage space where the first file is stored;
a first generating unit configured to generate second information based on the first storage address; and
a first saving unit configured to save the second information in association with the first information.

15. The electronic device of claim 14, further comprising:
a second detecting unit configured to detect and obtain a first operation by the first user with respect to the second information; and
a second processing unit configured to access, in response to the first operation, the first file in the network storage space based on the second information.

16. The electronic device of claim 14, further comprising:
a first deleting unit configured to delete the first file from the first information.

17. The electronic device of claim 14, wherein the first file is content a link in the first information is linked to, and the electronic device further comprises:
a content obtaining unit configured to obtain the content the link is linked to.

18. The electronic device of claim 17, wherein the linked content is stored in a network storage space associated with a second user, the linked content in the network storage space associated with the second user being accessible by a user other than the second user by accessing the link, the second user being different from the first user.

19. The electronic device of claim 18, further comprising:
a first obtaining unit configured to obtain a first storage address in the network storage space where the first file is stored; and
a link replacing unit configured to replace the link with the first storage address.

20. An electronic device, comprising
a processor, and
a storage coupled to the processor, wherein instructions are stored on the storage and when executed by the processor, cause the processor to perform the method of claim 1.
